(19) United States
(12) Patent Application Publication
(10) Pub. No.: US 2015/0003829 A1
(43) Pub. Date: Jan. 1, 2015

(54) Receptable Optical Amplifier

(71) Applicant: LiComm Co., Ltd., Yongin-si (KR)

(72) Inventors: Sung Jun KIM, Suwon-si (KR); Jeong Mee KIM, Suwon-si (KR); Soo Young YOON, Yongin-si (KR); Meong Kyu CHOI, Suwon-si (KR); Kyu HUR, Osan-si (KR); Jung Kwon LEE, Suwon-si (KR)

(21) Appl. No.: 14/315,740

(22) Filed: Jun. 26, 2014

(30) Foreign Application Priority Data
Jun. 27, 2013 (KR) 10-2013-0074148

(51) Int. Cl. H04B 10/40; H04Q 11/00

(52) U.S. Cl. CPC H04B 10/40; H04Q 11/0005; H04Q 2011/0013
USPC 398/48; 398/135

(57) ABSTRACT

Disclosed is a receptable optical amplifier. The receptable optical amplifier is detachably plugged in a switch device and has a pluggable type so as to be detachably plugged at a position in which a transceiver of the existing switch device is mounted. A body part 100 is provided with a placing part 112 therein, a controller 140 serving as a printed circuit board is mounted in the placing part 112, the controller 140 is provided with an EDF 160 at a lower portion thereof, and a passive and active device 150 at an upper portion thereof, and the receptable optical amplifier includes first and second isolators, a WDM coupler, a pumping LD, and a coupler equipped PD.

### BACKGROUND OF THE INVENTION

1. Field of the Invention

The present invention relates to a receptable optical amplifier, and more particularly, to a receptable optical amplifier which may be plugged in a typical transceiver position and may be detachably plugged.

2. Description of the Related Art

In order to additionally plug an amplifier in a transceiver which is equipped in a switch device and a transmission device of the related art, the amplifier needs to be separately plugged through a shelf separately manufactured or needs to be add in a card type, which may cause a problem in that the plugging of the amplifier is complicated and the plugging cost of the amplifier increases.

Further, the typical switch or transmission device is not designed to compatibly receive the amplifier with the transceiver. To receive the amplifier, the shelf for the switch or transmission device needs to be manufactured or the amplifier is plugged in a rack type. Therefore the amplifier needs to be plugged in a module type, not in a pluggable type.

However, in order to receive the amplifier in the typical device, the compatible problem may not be solved and thus the amplifier needs to be entirely newly manufactured.

### SUMMARY OF THE INVENTION

Accordingly, it is an object of the present invention to provide a new type of receptable optical amplifier which may have a transceiver removed therefrom when amplification is required and may be easily plugged in the removed position of the transceiver in a pluggable type, in the case in which the transmitter is equipped in the typical switch device in the pluggable type.

Another object of the present invention is to provide a receptable optical amplifier which may be compatibly plugged in the typical device.

According to an aspect of the present invention, there is provided a receptable optical amplifier, which is detachably plugged in an optical transmission device and a switch device and has a pluggable type.

Preferably, the receptable optical amplifier is compatible with transceivers which are detachably plugged at a position in which the transceivers of an existing optical transmission device and a switch device are mounted, in terms of electrical characteristics and mechanical characteristics.

Preferably, a body part is provided with a placing part therein, a controller serving as a printed circuit board is mounted in the placing part, the controller is provided with an EDF at a lower portion thereof and a passive and active device at an upper portion thereof, and the receptable optical amplifier includes first and second isolators, a WDM coupler, a pumping LD, and a coupler equipped PD.

Preferably, the receptable optical amplifier is compatible with an XFP among transceivers which are detachably plugged at positions in which the transceivers of the existing optical transmission device and switch device are mounted, in terms of electrical characteristics and mechanical characteristics.

According to the receptable optical amplifier of the present invention having the above-described configuration, when the transmitter is equipped in the typical switch device in the pluggable type, the transceiver may be removed if the amplification is required and the receptable optical amplifier may be easily plugged in the removed position of the transceiver in the pluggable type, thereby increasing the user convenience, simplifying the use of the amplifier, and saving the plugging costs and time of the amplifier.

### BRIEF DESCRIPTION OF THE DRAWINGS

The above and other objects, features and advantages of the present invention will become apparent from the following description of preferred embodiments given in conjunction with the accompanying drawings, in which:

FIG. 1 is a block diagram illustrating a configuration of a receptable optical amplifier according to an embodiment of the present invention;

FIG. 2 is a block diagram conceptually illustrating a plugging state of the receptable optical amplifier according to the embodiment of the present invention; and

FIG. 3 is a side cross-sectional view schematically illustrating an appearance of the receptable optical amplifier according to the embodiment of the present invention.

### DETAILED DESCRIPTION OF THE INVENTION

Hereinafter, a receptable optical amplifier according to an embodiment of the present invention will be described.

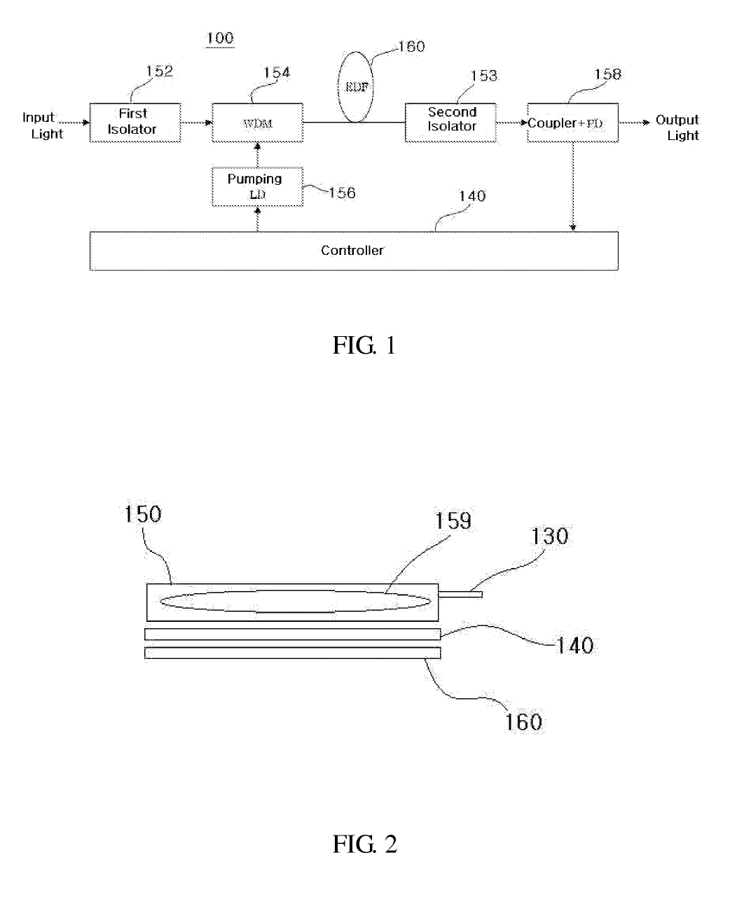

Referring to FIG. 1, a receptable optical amplifier 100 according to an embodiment of the present invention includes a first isolator 152 configured to process input light, a WDM coupler 154 configured to process a signal using the first isolator 152, a pumping LD 156 configured to pump the signal to the WDM coupler 154, a second isolator 153 configured to process the signal from the WDM coupler 154, a coupler equipped PD 158 configured to process the signal from the second isolator 153, and a controller 140 configured to output a control signal which controls the pumping LD 156 according to the signal from the coupler equipped PD 158.

Herein, the coupler equipped PD represents that the coupler and the PD is formed in one unit, and in another embodiment, it may be individually formed as a separate device.

The coupler, the isolator, and the wavelength division multiplexer (WDM) are a passive optical device and the photo diode (PD) and the pumping LD are an active optical device. An optical fiber 159 is connected to an optical module.

The input optical signal is isolated into, for example, 99:1 by a coupler (not illustrated, disposed before the first isolator and then connected through the PD (not illustrated)), the input light corresponding to “99” is output to the WDM 154 through the first isolator 152, and the input light corresponding to “1” is converted into an electrical signal through the PD (not illustrated, disposed before the first isolator 154) and then is transferred to the controller 140. In addition, the WDM 154 provides the input light applied through the first isolator 152 and the pumping light applied from the pumping LD 156 to an EDF 160 by a forward excitation scheme, in which the EDF 160 is configured to amplify the input light to a predetermined level and then be output through the second isolator 153.

Further, the coupler equipped PD 158 is coupled with an output terminal through the second isolator 153 to isolate the amplified optical signal into, for example, 99:1 by the coupler and output the amplified light corresponding to “99” as output light and convert the amplified light corresponding to “1” into an electrical signal by the photo diode (PD) and then apply the converted electrical signal to the controller 140.

The controller controls strength of the pumping light output through the pumping LD 156 based on the optical signal applied from a PD (not illustrated) and the PD 158 of the coupler equipped PD so as to output the optical signal having predetermined strength at all times.

Referring to FIG. 2, the receptable optical amplifier 100 according to the embodiment of the present invention has a body part and a placing part provided within the body. The controller 140 is mounted in the placing as a printed circuit board.

The controller 140 is provided with the EDF 160 at a lower portion thereof and a passive and active device 150 at an upper portion thereof. That is, the receptable optical amplifier 100 includes the first and second isolators, the WDM coupler, the pumping LD, and the coupler equipped PD.

An electrical connector 130 functions to transmit the electrical signal between all devices included in the receptable optical amplifier 100. Further, one end of an XOA device is electrically connected to a female jack or a male jack.

As described above, the optical fiber 159 is connected to the optical module.

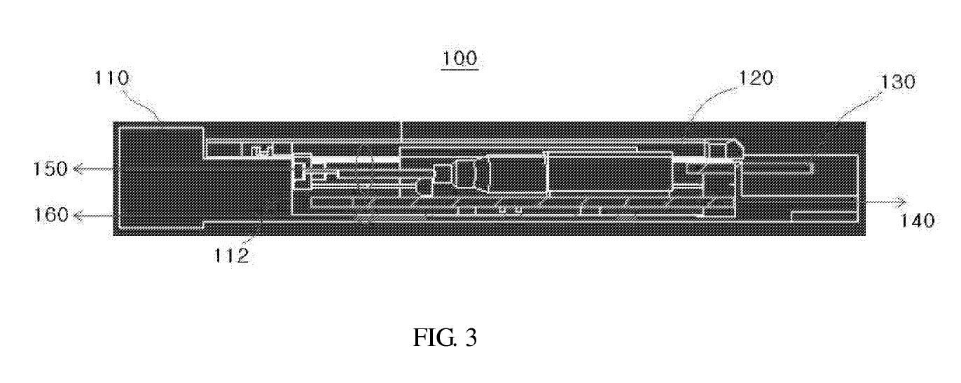

Referring to FIG. 3, in the receptable optical amplifier 100 according to the embodiment of the present invention, the placing part 112 is provided within the body part 100 and the controller 140 is mounted in the placing part 112 as the printed circuit board.

The controller 140 is provided with the EDF 160 at the lower portion thereof and the passive and active device 150 at the upper portion thereof. That is, the receptable optical amplifier 100 includes the first and second isolators, the WDM coupler, the pumping LD, and the coupler equipped PD.

The electrical connector 130 functions to transmit the electrical signal between all devices included in the receptable optical amplifier 100. Further, one end of the XOA device is electrically connected to the female jack or the male jack.

In the receptable optical amplifier according to the embodiment of the present invention, the input and output parts at a position in which the existing transceiver is equipped are used without any change. That is, the receptable optical amplifier according to the embodiment of the present invention may be compatibly used at the transmitting and receiving position of the existing transceiver.

When the receptable optical amplifier according to the embodiment of the present invention is plugged in the switch of the existing transmission device, the device is recognized that the amplifier is inserted into the corresponding port and the signal is processed. Further, when the receptable optical amplifier EDFA is plugged in the transmitter position, the amplifier is operated according to the operation of the transceiver.

When the typical transceiver is plugged, the transceiver processes the optical signal, and in the case of the switch device, the receiver receives the signal and when data are received, converts the optical signal into the electrical signal. The switch device serves as frame analysis switching and the transmission device performs a multiplexing/demultiplexing process.

That is, the switch device converts the received optical signal into the electrical signal to be output. When the receptable optical amplifier EDFA according to the embodiment of the present invention is used, the amplifier has only the input and output, and therefore amplifies only light at the input side and again inputs the amplified light to the input side.

In some cases, the transceiver may be equipped in the same port. Alternatively, the receptable optical amplifier EDFA may also be inserted. There is a system of allowing a recognizing part to process data, that is, each port to monitor and control signals input to the transceiver. That is, the pluggable amplifier according to the embodiment of the present invention may be physically operated without any problem and may be used in every case.

In other words, when the receptable optical amplifier according to the embodiment of the present invention is plugged, there is no need to modify a function performed by an original switch of the switch device or a function performed by the transmission device.

According to the embodiment of the present invention, the receptable optical amplifier may be implemented by a receptable type and a pluggable type.

In addition, the receptable optical amplifier may be used by being inserted and pluggable into the original transmitting and receiving module position.

Further, the receptable optical amplifier may be compatibly used with the transceiver structure called an XFP which is most widely used in the world today.

Furthermore, the receptable optical amplifier may be applied to the XFP which is small in size and frequently used.

While the present invention has been described with reference to the preferred embodiments, it will be understood by those skilled in the related art that various modifications and variations may be made therein without departing from the scope of the present invention as defined by the appended claims.

What is claimed is:

1. A receptable optical amplifier, which is detachably plugged in an optical transmission device and a switch device and has a pluggable type.

2. The receptable optical amplifier of claim 1, wherein the receptable optical amplifier is compatible with transceivers which are detachably plugged at a position in which the transceivers of an existing optical transmission device and a switch device are mounted, in terms of electrical characteristics and mechanical characteristics.

3. The receptable optical amplifier of claim 1, wherein a body part is provided with a placing part therein,
a controller serving as a printed circuit board is mounted in the placing part,
the controller is provided with an EDF at a lower portion thereof and a passive and active device at an upper portion thereof, and
the receptable optical amplifier includes first and second isolators, a WDM coupler, a pumping LD, and a coupler equipped PD.

4. The receptable optical amplifier of claim 2, wherein the receptable optical amplifier is compatible with an XFP among transceivers which are detachably plugged at positions in which the transceivers of the existing optical transmission device and switch device are mounted, in terms of electrical characteristics and mechanical characteristics.
